(19) United States
(12) Patent Application Publication
(10) Pub. No.: US 2024/0083264 A1
(43) Pub. Date: Mar. 14, 2024

(54) BATTERY RELAY SYSTEM TO OBTAIN CONSTANT AUTONOMY OF THE VEHICLE

(71) Applicant: JORGE RAMIRO BARRAGAN, EL PASO, TX (US)

(72) Inventor: JORGE RAMIRO BARRAGAN, EL PASO, TX (US)

(21) Appl. No.: 18/382,495

(22) Filed: Oct. 21, 2023

(51) Int. Cl. B60L 50/60; B60L 53/22; B60L 58/19

(52) U.S. Cl. CPC B60L 50/66; B60L 53/22; B60L 58/19

(57) ABSTRACT

Industrial application. This system is useful in the production of vehicles powered by electric energy. with this precise system of relay of batteries, a work is carried out in battery equipment, guaranteeing a reliable relay cycle, of complete autonomy.

### BACKGROUND

Industry dedicated to the production of electric vehicles. The objective of this system is to solve the problem of autonomy of travel of the electric vehicle by having to make stops with high periods of time to recharge the battery with an outlet, as well as the problem that occurs when standing on the road, without an immediate place to recharge the battery when it is already exhausted its charge. An efficient concept is present within the fuel of automobile and other vehicles powered by electric motors; to avoid the reliance of complicated recharges in special stations when it only provides limited milage. The main objective of this system is to provide the vehicle with power independence of movement and functionality.

### Technical Problem

The technical problem to be solved is the limitations in the load capacity of the batteries in electric vehicles of not having the vehicle with a reliable and total autonomy of travel, such as the danger of being stranded on the road. As well as the expense of having to install countless charging stations and the time it represents waiting to be able to have enough charge to continue the vehicle in operation. Like the vehicles that have solar cells, it is about solving the problem of invulnerability to certain climatic changes.

### Solution to the Problem

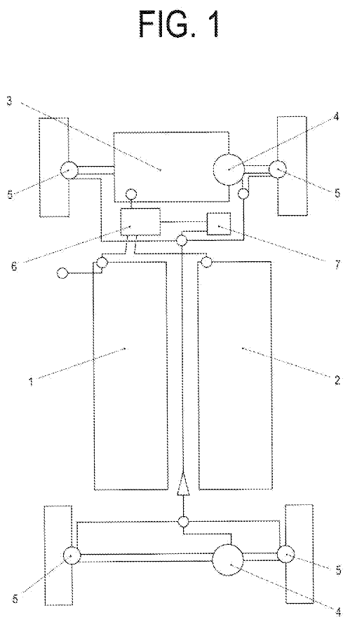

The solution Fundamentally it consists of having the vehicle with a system based on the installation of two or more batteries, (FIG. 1), Battery (1) Battery (2) with the automatic relay function, or with manual Controls on the vehicle dashboard, to solve the autonomy problem, obtaining an optimal and constant efficiency of travel. The batteries work with a recharging system, programmed, which will give us a relay action in equipment, which consists of that, when the power decreases in the path of the battery in function, immediately enter the next one relieving this in its work, at the precise moment resulting in the continuous electrical and motor, (FIG. 1) (3), operation, therefore, obtaining a constant autonomy of the vehicle's travel. So, while one is working, feeding, and maintaining the function of the vehicle, the next in reserve will be charged to be ready to act immediately in relief, complementing the cycle of total autonomy.

To integrate this relay system, one or more current electrical alternators, o well electric generators shall be installed in the vehicle, same taking advantage the energy obtained from one or more solar cells sources of the vehicle who can count on this form of supply, such as the same use the arrows, or shafts (FIG. 1) (4). Or wheels, (FIG. 1) (5), as well as one distributor, (FIG. 1) (6) and regulating de energy, (FIG. 1). (7). We have the advantage of having several ways to obtain the production of electrical energy from the generators' that they work taking advantage of the rotation of different shafts and the vehicle rotors, therefore with this, we with this achieve a reliable system of relay effective alternative of recharging of batteries, that will give us the safety of handling and travel with total permanent autonomy.

### Advantageous Effects

The advantages and effects derived from this battery relay system is fundamentally the obtaining of a power constant, and efficient energy for the supply of the motor as well as the electrical parts, achieving unlimited autonomy of travel. As well as a considerable savings are also obtained by reducing the number of charging stations, both in the city and on the road.

### BRIEF DESCRIPTION OF THE DRAWING

FIG. 1
1.—Battery
2.—Battery
3.—Motor
4.—Arrows
5.—Wheels
6.—Distributor
7.—Regulating

### BRIEF SYSTEM DESCRIPTION

I describe this idea, which basically consists of equipping the vehicle with a battery relay system, automatic programed of self-charging of batteries by means of electric generators installed in the vehicle taking advantage of the revolutions of the arrows. Since when putting into practice this relay system, you end up with the problem and frustration of staying on the road when the battery is discharged, even in the city, the loss of time to recharge the battery, even being able to locate a point for recharging, you still get a great saving by not being necessary the installation of stations or charging points. So, with this precise system of relay of batteries a work is carried out in battery equipment, guaranteeing a reliable relay cycle, of complete autonomy.

1. Battery Relay system. With two or more batteries to provide constant and unlimited autonomy to the electric vehicle.
